(19) United States
(12) Patent Application Publication
(10) Pub. No.: US 2024/0075840 A1
(43) Pub. Date: Mar. 7, 2024

(54) Power Management System and Power Management Method

(71) Applicant: TOYOTA JIDOSHA KABUSHIKI KAISHA, Toyota-shi Aichi-ken (JP)

(72) Inventors: Osamu YUMITA, Seto-shi Aichi-ken (JP); Yoichi ONISHI, Okazaki-shi Aichi-ken (JP); Toru ANDO, Obu-shi Aichi-ken (JP); Ikuma SUZUKI, Okazaki-shi Aichi-ken (JP); Yu NAGATA, Chofu-shi Tokyo-to (JP)

(73) Assignee: TOYOTA JIDOSHA KABUSHIKI KAISHA, Toyota-shi Aichi-ken (JP)

(21) Appl. No.: 18/239,477

(22) Filed: Aug. 29, 2023

(30) Foreign Application Priority Data
Sep. 7, 2022 (JP) 2022-142216

(51) Int. Cl. B60L 53/62; B60L 53/18; B60L 53/67; B60L 53/68

(52) U.S. Cl. CPC B60L 53/62; B60L 53/18; B60L 53/67; B60L 53/68

(57) ABSTRACT

A VGI system includes a plurality of BEVs, a plurality of pieces of EVSE, and a server. The server determines whether the BEV exchanges electric power with a power grid with the use of second EVSE provided in a second area, the second area being different in manner of management of power supply by the power grid from a first area where predetermined first EVSE is provided, the first EVSE being normally used by the BEV. When the server determines that the BEV exchanges electric power with the use of the second EVSE and when the second area is higher than the first area in contribution to DR in exchange of electric power by the BEV, the server grants an incentive higher than in exchange of electric power with the power grid with the use of the first EVSE.

### CROSS REFERENCE TO RELATED APPLICATIONS

This nonprovisional application is based on Japanese Patent Application No. 2022-142216 filed with the Japan Patent Office on Sep. 7, 2022, the entire contents of which are hereby incorporated by reference.

### BACKGROUND

### Field

This disclosure relates to a power management system and a power management method, and particularly to a power management system in which electric power is exchanged between a power supply and demand system of an electric power trading partner and a vehicle and a power management method in a power management system in which electric power is exchanged between a power supply and demand system of an electric power trading partner and a vehicle.

### Description of the Background Art

A virtual power plant (which will be referred to as a “VPP” below) that uses an electric vehicle as a power supply has conventionally been available (see, for example, Japanese Patent Laying-Open No. 2021-129441).

### SUMMARY

In some embodiments, an electric power service, demand or supply of electric power is leveled between/among areas. Demand or supply of electric power, however, is different from area to area.

This disclosure was made to solve such a problem, and an object thereof is to provide a power management system and a power management method capable of contributing to leveling of demand or supply of electric power.

A power management system according to this disclosure is a system in which electric power is exchanged between a power supply and demand system of an electric power trading partner and a vehicle. The power management system includes a plurality of vehicles, a plurality of charging and discharging apparatuses each including a cable through which electric power exchanged with the vehicle passes and a connector for connection of the cable to the vehicle, and a server that manages exchange of electric power. In a first area, a predetermined first charging and discharging apparatus normally used by the vehicle for exchange of electric power with the power supply and demand system is provided. A second charging and discharging apparatus is provided in a second area different from the first area in manner of management of power supply by the power supply and demand system. The server determines whether the vehicle exchanges electric power with the power supply and demand system by using the second charging and discharging apparatus. When the server determines that the vehicle exchanges electric power by using the second charging and discharging apparatus and when the second area is higher than the first area in contribution to demand response in exchange of electric power by the vehicle, the server grants an incentive higher in value than in exchange of electric power with the power supply and demand system by using the first charging and discharging apparatus.

According to such a configuration, movement of a vehicle to an area where contribution to demand response is high can be encouraged. Consequently, the power management system capable of contributing to leveling of demand or supply of electric power can be provided.

The server may propose to a user of the vehicle, demand response in which the vehicle can participate in the second area.

According to such a configuration, movement of the vehicle to the second area can be encouraged, which can result in contribution to leveling of demand or supply of electric power in the second area.

The server may show the user of the vehicle, contribution by the vehicle for each demand response in the second area.

According to such a configuration, movement of the vehicle to the second area can be encouraged, which can result in contribution to leveling of demand or supply of electric power in the second area.

The server may propose to the user of the vehicle, demand response in which the vehicle can participate on condition that the connector of the second charging and discharging apparatus is connected to the vehicle.

According to such a configuration, an incentive can be granted on condition that a state in which contribution to demand response can actually be made has been set.

According to another aspect of this disclosure, a power management method is a method of managing electric power in a power management system in which electric power is exchanged between a power supply and demand system of an electric power trading partner and a vehicle. The power management system includes a plurality of vehicles, a plurality of charging and discharging apparatuses each including a cable through which electric power exchanged with the vehicle passes and a connector for connection of the cable to the vehicle, and a server that manages exchange of electric power. In a first area, a predetermined first charging and discharging apparatus normally used by the vehicle for exchange of electric power with the power supply and demand system is provided. A second charging and discharging apparatus is provided in a second area different from the first area in manner of management of power supply by the power supply and demand system. The power management method includes determining, by the server, whether the vehicle exchanges electric power with the power supply and demand system by using the second charging and discharging apparatus and granting, by the server, when the server determines that the vehicle exchanges electric power by using the second charging and discharging apparatus and when the second area is higher than the first area in contribution to demand response in exchange of electric power by the vehicle, an incentive higher in value than in exchange of electric power with the power supply and demand system by using the first charging and discharging apparatus.

According to such a configuration, a power management method capable of contributing to leveling of demand or supply of electric power can be provided.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a configuration of a VGI system according to this embodiment.

FIG. 2 is a diagram of a communication system of a VGI system 1.

FIG. 3 is a diagram showing a configuration of a BEV.

FIG. 4 is a diagram showing an input apparatus and a notification apparatus mounted in the vicinity of a driver's seat of the BEV.

FIG. 5 is a diagram for illustrating the BEV connected to public EVSE.

FIG. 6 is a diagram showing a flow of processing for granting an incentive for participation in a VPP.

### DESCRIPTION OF THE EMBODIMENTS

An embodiment of the present disclosure will be described in detail below with reference to the drawings. The same or corresponding elements in the drawings have the same reference characters allotted and description thereof will not be repeated.

An electric power system dependent on a large-scale power plant (an intensive energy resource) possessed by an electric power utility company has recently been reviewed and a scheme for utilizing an energy resource possessed by each demand side (which is also referred to as “demand side resources (DSR)” below) has been constructed. The DSR functions as distributed energy resources (which are also referred to as “DER” below).

A virtual power plant (VPP) has been proposed as a scheme for utilizing the DSR for an electric power system. The VPP refers to a scheme in which a large number of DER (for example, DSR) are put together according to a sophisticated energy management technology that makes use of the Internet of Things (IoT) and the DER are remotely controlled as being integrated as if the DER functioned as a single power plant. In the VPP, an electric utility that puts the DER together to provide an energy management service is referred to as an “aggregator.” An electric power utility company, for example, in coordination with an aggregator, can balance between supply and demand of electric power based on demand response (DR).

In a vehicle grid integration (VGI) system according to this embodiment, a vehicle including a power storage (more specifically, an electric vehicle (an electrically powered vehicle capable of external charging and discharging such as a battery electric vehicle (BEV) and a plug-in hybrid electric vehicle (PHEV) below) is adopted as DSR for implementing the VPP.

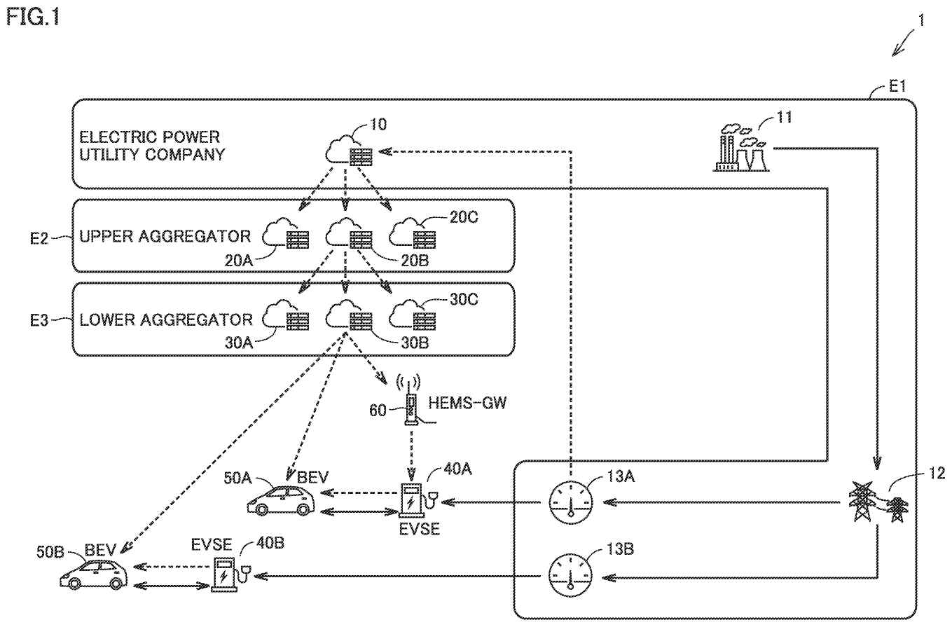

FIG. 1 is a diagram showing a configuration of a VGI system according to this embodiment. Referring to FIG. 1, a VGI system 1 includes an electric power utility company E1, an upper aggregator E2, and a lower aggregator E3.

Electric power utility company E1 generates and supplies electric power. Electric power utility company E1 can make a profit, for example, by dealing with a demand side (for example, an individual or a company) that uses electric power. Electric power utility company E1 maintains and manages a server 10, a power plant 11, a power transmission and distribution facility 12, and smart meters 13A and 13B.

Power plant 11 includes a power generator that generates electricity and supplies electric power generated by the power generator to power transmission and distribution facility 12. Any system for power generation by power plant 11 is applicable, and for example, any of thermal power generation, hydroelectric power generation, wind power generation, nuclear power generation, and solar photovoltaic power generation may be applicable. Power transmission and distribution facility 12 includes a power line, a substation, and an electricity distribution line and transmits and distributes electric power supplied from power plant 11. Power plant 11 and power transmission and distribution facility 12 construct a power grid (power system).

Each of smart meters 13A and 13B measures an amount of power usage each time a prescribed time period elapses (for example, each time thirty minutes elapse), stores the measured amount of power usage, and transmits the measured amount of power usage to server 10. For example, IEC (DLMS/COSEM) can be adopted as a protocol for communication between smart meters 13A and 13B and server 10. Each of smart meters 13A and 13B measures an amount of power usage in EVSE 40A and 40B which will be described later (for example, an amount of electric power used for charging of BEVs 50A and 50B). Electric power utility company E1 corresponds to a managerial utility of each of EVSE 40A and EVSE 40B.

Each utility (which is also referred to as a “parent AG” below) belonging to upper aggregator E2 manages a plurality of utilities (each of which is also referred to as a “child AG” below) belonging to lower aggregator E3 and provides an energy management service by putting together amounts of electric power controlled by children AGs under the control thereof. The parent AG can make a profit, for example, by dealing with electric power utility company E1.

Server 10 manages information on a plurality of parent AGs (for example, parent AGs registered in server 10) under the control thereof. Identification information (ID) for identification of a parent AG is provided for each parent AG. Server 10 manages information for each parent AG as being distinguished based on an ID of the parent AG. The parent AG may procure performance (capacity) of supply of electricity not only from a battery electric vehicle (BEV) but also from a resource other than the BEV (for example, biomass). Upper aggregator E2 includes a plurality of servers (for example, servers 20A to 20C) provided for respective parent AGs. The server included in upper aggregator E2 is denoted as a “server 20” except for an example in which the servers are described as being distinguished from one another. Though FIG. 1 shows three servers 20 (servers 20A to 20C), any number of servers 20 may be included in upper aggregator E2 and ten or more servers may be included.

Each server 20 included in upper aggregator E2 manages information on children AGs (for example, children AGs registered in server 20) under the control thereof. Each utility (child AG) belonging to lower aggregator E3 controls an amount of electric power by requesting each demand side to suppress or increase power demand by issuing a demand response signal (DR signal). Identification information (ID) for identification of a child AG is provided for each child AG. Server 20 manages information for each child AG as being distinguished based on an ID of the child AG. Lower aggregator E3 includes a plurality of servers (for example, servers 30A to 30C) provided for respective children AGs. The server included in lower aggregator E3 is denoted as a “server 30” below except for an example in which the servers are described as being distinguished from one another. Servers 30A to 30C shown in FIG. 1 are managed by common server 20 (for example, server 20B). Any number of servers 30 may be managed by each server 20 included in upper aggregator E2, and ten or more servers may be managed.

A battery electric vehicle (BEV) is adopted as the demand side managed by a child AG (or server 30) in VGI system 1 shown in FIG. 1. The BEV can be supplied with electric power by electric vehicle supply equipment (EVSE). In this embodiment, VGI system 1 includes both of EVSE adapted to an alternating-current electric power supply type (an AC type) and EVSE adapted to a direct-current electric power supply type (a DC type).

EVSE 40A included in VGI system 1 shown in FIG. 1 is home EVSE (that is, EVSE installed in a house). The home EVSE can be managed by a home energy management system-gateway (HEMS-GW). For example, EVSE 40A is managed by a HEMS-GW 60. EVSE 40B included in VGI system 1 shown in FIG. 1 is public EVSE. The public EVSE is installed, for example, in public facilities, commercial facilities, accommodations, and parking lots (for example, service areas of highways) as an infrastructure for charging of a power storage mounted on an electrically powered vehicle. Typical examples of public EVSE include a normal charger adapted to the AC type and a quick charger adapted to the DC type.

VGI system 1 includes a plurality of pieces of EVSE, a plurality of BEVs, and a plurality of HEMS-GWs (only one of each of them being shown in FIG. 1). Any independent number of pieces of EVSE, BEVs, and HEMS-GWs may be included in VGI system 1, and the number may be set to ten or more or one hundred or more. Each piece of EVSE, each BEV, and each HEMS-GW included in VGI system 1 are denoted as “EVSE 40,” “BEV 50,” and “HEMS-GW 60,” respectively, except for an example in which each of them is described as being distinguished. Each BEV 50 included in VGI system 1 may be a vehicle owned by an individual (which is also referred to as a “POV” below) or a vehicle managed by a mobility as a service (MaaS) entity (which is also referred to as a “MaaS vehicle” below). In this embodiment, a user of each BEV 50 included in VGI system 1 enters into a contract with electric power utility company E1. Under this contract, the user obtains the right to receive a reward from electric power utility company E1 when the user adjusts power demand in response to a request by electric power utility company E1.

Each server 30 included in lower aggregator E3 manages information on a plurality of BEVs 50 (for example, BEVs registered in server 30) under the control thereof. Identification information for identification of BEV 50 (which is also referred to as a “vehicle ID” below) is provided for each BEV 50. Server 30 manages information for each BEV 50 as being distinguished based on the vehicle ID. Each server 30 included in lower aggregator E3 can communicate with each HEMS-GW 60 (for example, a HEMS-GW registered in server 30) under the control thereof.

EVSE 40A is connected to the power grid of electric power utility company E1 with smart meter 13A being interposed. An amount of power usage in EVSE 40A is measured by smart meter 13A and transmitted to server 10. EVSE 40B is connected to the power grid of electric power utility company E1 with smart meter 13B being interposed. An amount of power usage in EVSE 40B is measured by smart meter 13B and transmitted to server 10. Each of smart meters 13A and 13B included in VGI system 1 is denoted as a “smart meter 13” below except for an example in which the smart meters are described as being distinguished from each other.

Smart meter 13 is provided for each piece of EVSE 40 included in VGI system 1. Each piece of EVSE 40 included in VGI system 1 is managed by electric power utility company E1 and connected to the power grid provided by electric power utility company E1. Each piece of EVSE 40 included in VGI system 1 is supplied with electric power from electric power utility company E1. In VGI system 1, identification information for identification of EVSE 40 (which is also referred to as a “facility ID” below) is provided for each piece of EVSE 40, and server 10 manages an amount of power usage in each piece of EVSE 40 as being distinguished based on the facility ID. Electric power utility company E1 monitors an amount of electric power used in each piece of EVSE 40 included in VGI system 1 (that is, an amount of supply of electric power to a demand side) through smart meter 13 and provides electric power to the demand side through each piece of EVSE 40 included in VGI system 1.

A plurality of pieces of EVSE 40 included in VGI system 1 include a charging facility not adapted to backfeeding and a charging facility adapted to backfeeding (that is, a charging and discharging facility). The charging and discharging facility supplies electric power received from BEV 50 to the power grid of electric power utility company E1 (that is, backfeeding). Smart meter 13 provided in the charging and discharging facility measures an amount of backfed electric power in addition to an amount of power usage.

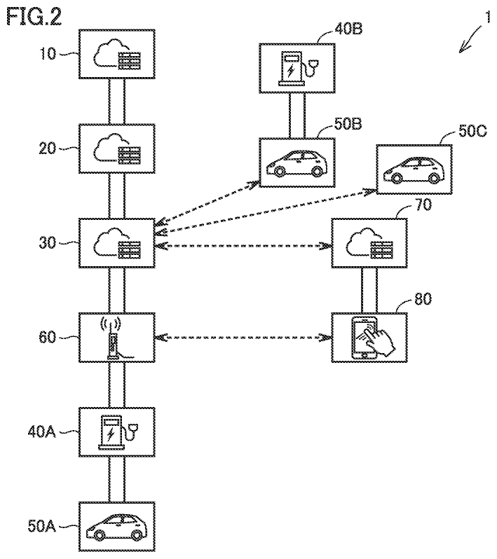

A function of each element included in VGI system 1 will be described below with reference to FIG. 2. FIG. 2 is a diagram of a communication system of VGI system 1. In FIG. 2, BEV 50A is electrically connected to EVSE 40A (home EVSE) through a charging cable. BEV 50B is electrically connected to EVSE 40B (public EVSE) through a charging cable. A BEV 50C is traveling.

Referring to FIG. 2, in VGI system 1, server 10 and server 20 can communicate with each other. Server 20 and server 30 can also communicate with each other. Though communication between servers 10 and 20 and between servers 20 and 30 may be independently of any type, for example, a virtual private network (VPN) may be adopted.

Server 30 can communicate with each of each BEV 50 (that is, BEVs 50A to 50C) and HEMS-GW 60. Server 30 and HEMS-GW 60 communicate with each other, for example, through the Internet. Server 30 and each BEV 50 wirelessly communicate with each other, for example, through a mobile communication network (telematics).

HEMS-GW 60 and EVSE 40A communicate with each other, for example, through a local area network (LAN). The LAN may be wired or wireless LAN.

EVSE 40A and BEV 50A communicate with each other through a charging cable. EVSE 40B and BEV 50B communicate with each other also through a charging cable. Communication between EVSE 40A and BEV 50A and between EVSE 40B and BEV 50B may be independently of any type, and controller area network (CAN) or power line communication (PLC) may be adopted.

VGI system 1 further includes a data center 70 and a portable terminal 80 registered in data center 70. Data center 70 includes, for example, a server (not shown) that manages information. In this embodiment, a smartphone equipped with a touch panel display is adopted as portable terminal 80. Without being limited thereto, any portable terminal can be adopted as portable terminal 80, and for example, a tablet terminal, a portable game console, and a wearable device such as a smart watch can also be adopted.

Data center 70 communicates with server 30, for example, through the Internet. Data center 70 manages information on a plurality of registered portable terminals 80. Information on portable terminal 80 includes not only information on the terminal itself (for example, a communication address of portable terminal 80) but also information on a user who carries portable terminal 80 (for example, information that indicates an electric utility with which the user has contracted and a vehicle ID of BEV 50 belonging to the user). Identification information for identification of portable terminal 80 (which is also referred to as a “terminal ID” below) is provided for each portable terminal 80 and data center 70 manages information for each portable terminal 80 as being distinguished based on the terminal ID. The terminal ID also functions as information for identification of a user (a user ID). Though FIG. 2 shows only a single portable terminal 80, each user carries portable terminal 80.

Prescribed application software (which is simply referred to as an “application” below) is installed in portable terminal 80, and portable terminal 80 exchanges information with each of HEMS-GW 60 and data center 70 through the application. Portable terminal 80 wirelessly communicates with each of HEMS-GW 60 and data center 70, for example, through the Internet.

Server 10 balances between supply and demand of electric power by using demand response (DR). When server 10 makes such adjustment, initially, it transmits a signal (which is also referred to as a “DR participation request” below) requesting each server 20 (for example, servers 20A to 20C shown in FIG. 1) included in upper aggregator E2 to participate in DR. The DR participation request includes a region of interest of DR, a type of DR (for example, DR suppression (negawatt DR) or DR increase (posiwatt DR)), and a DR period.

When server 20 receives a DR participation request from server 10, it calculates an adjustable DR amount (that is, an amount of electric power that can be adjusted in accordance with DR) and transmits the amount to server 10. Server 20 can calculate the adjustable DR amount, for example, based on a total of DR capacities of children AGs (that is, a capacity with which the children AGs can address DR) under the control thereof. Server 20 can obtain the DR capacity of each child AG under the control thereof, for example, by making an inquiry to server 30. Server 10 determines a DR amount (that is, an amount of power adjustment asked to a parent AG) for each parent AG based on the adjustable DR amount received from each server 20 included in upper aggregator E2 and transmits a signal (which is also referred to as a “first DR execution instruction” below) instructing server 20 of each parent AG to execute DR. The first DR execution instruction includes a region of interest of DR, a type of DR (for example, DR suppression or DR increase), an amount of DR for the parent AG, and a DR period.

Server 30 sequentially obtains from each BEV 50, information (for example, a position of a vehicle, a remaining capacity of a battery, a travel schedule, and a travel condition) representing a state of each BEV 50 under the control thereof and stores the information. As a result of accumulation of such data, a history of charging and discharging and a history of travel of each BEV 50 under the control are stored in server 30. Server 30 sequentially obtains from each HEMS-GW 60 connected to each piece of EVSE 40, information representing a state (for example, information indicating whether or not the vehicle is being charged, a schedule for charging, and a condition for charging) of each piece of EVSE 40 under the control thereof and stores the information. As a result of accumulation of such data, a history of charging and a history of backfeeding of each piece of EVSE 40 under the control are stored in server 30.

A user can transmit information representing a state and a schedule of the user to data center 70 by operating portable terminal 80. Exemplary information representing a state of the user includes information indicating whether or not the user is in a condition of being ready for addressing DR. Exemplary information representing the schedule of the user includes time of departure of a POV from home or a drive plan of a MaaS vehicle. Data center 70 stores the information received from portable terminal 80 as being distinguished for each terminal ID. Server 30 can obtain information on the user from data center 70.

When server 30 receives the previously-described inquiry from server 20, server 30 calculates the DR capacity of a child AG corresponding thereto based on information on each of BEV 50, EVSE 40, and the user described above, and transmits the DR capacity to server 20. When server 20 receives the previously-described first DR execution instruction from server 10, server 20 determines a DR amount for each child AG (that is, an amount of electric power of which adjustment is asked to the child AG) based on the DR capacity received from each server 30 included in lower aggregator E3 and transmits a signal (which is also referred to as a “second DR execution instruction” below) that instructs server 30 of each child AG to execute DR. The second DR execution instruction includes a region of interest of DR, a type of DR (for example, DR suppression or DR increase), an amount of DR for the child AG, and a DR period.

When server 30 receives the second DR execution instruction, it allocates the DR amount to each BEV 50 that can address DR among BEVs 50 under the control thereof, generates a DR signal for each BEV 50, and transmits the DR signal to each BEV 50. The DR signal includes a type of DR (for example, DR suppression or DR increase), an amount of DR for BEV 50, and a DR period. A DR amount in DR increase requested to BEV 50 during the DR period may be, for example, charging power during the DR period or an amount of charging during the DR period (that is, a time integrated value of charging power). A DR amount in DR suppression requested to BEV 50 during the DR period may be, for example, an amount of discharging during the DR period (that is, a time integrated value of discharging power) or a guard value for restriction of charging power (an upper limit value of charging power) during the DR period.

When the user of each BEV 50 included in VGI system 1 receives the DR signal, the user can contribute to adjustment of an amount of power demand by performing charging or discharging in accordance with DR by using a charging facility (that is, any of a plurality of pieces of EVSE 40 included in VGI system 1) managed by electric power utility company E1 which is the contracted utility. Then, the user who has contributed to adjustment of the amount of power demand has the right to receive a reward (compensation for contribution) from electric power utility company E1 based on the contract with electric power utility company E1 described previously.

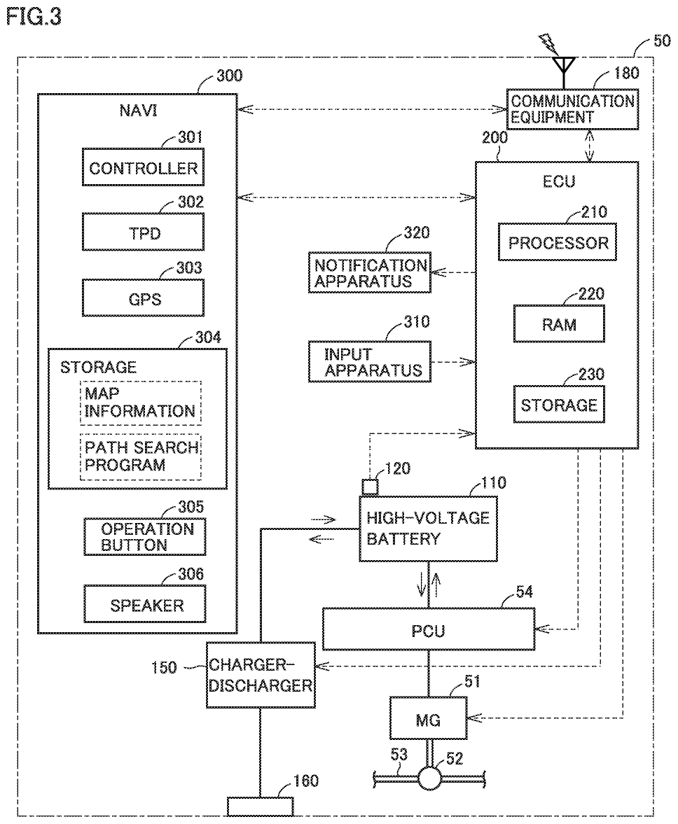

FIG. 3 is a diagram showing a configuration of BEV 50. Referring to FIG. 3, BEV 50 includes a motor generator (which is referred to as an “MG” below) 51, a motive power transmission gear 52, a driveshaft 53, a power control unit (which is referred to as a “PCU” below) 54, a high-voltage battery 110, a monitoring unit 120, a charger-discharger 150, an inlet 160, communication equipment 180, an electronic control unit (which is referred to as an “ECU” below) 200, a car navigation system (which is also referred to as a “NAVI system” below) 300, an input apparatus 310, and a notification apparatus 320. ECU 200 controls charging and discharging of high-voltage battery 100.

High-voltage battery 110 stores electric power for traveling. High-voltage battery 110 includes, for example, a secondary battery such as a lithium ion battery or a nickel metal hydride battery. The secondary battery may be a cell or a battery assembly. Instead of the secondary battery, another power storage such as an electric double layer capacitor may be adopted.

Inlet 160 receives electric power supplied from the outside of BEV 50. A connector 43 of a charging cable 42 can be connected to inlet 160.

Charger-discharger 150 is located between inlet 160 and high-voltage battery 110. Charger-discharger 150 includes a relay that switches between connection and disconnection of an electric power path from inlet 160 to high-voltage battery 110 and a power conversion circuit (for example, a bidirectional converter) (neither of which is shown). Each of the relay and the power conversion circuit included in charger-discharger 150 is controlled by ECU 200.

As EVSE 40 outside BEV 50 and inlet 160 are connected to each other through charging cable 42, electric power can be supplied and received between EVSE 40 and BEV 50. For example, electric power can be supplied from the outside of BEV 50 to charge high-voltage battery 110 of BEV 50 (which is also referred to as “external charging” below). Electric power for external charging is supplied, for example, from EVSE 40 through charging cable 42 to inlet 160. Charger-discharger 150 converts electric power received at inlet 160 into electric power suitable for charging of high-voltage battery 110 and outputs resultant electric power to high-voltage battery 110. As EVSE 40 and inlet 160 are connected to each other through charging cable 42, electric power can be fed (and high-voltage battery 110 can be discharged) from BEV 50 through charging cable 42 to EVSE 40. Electric power for power feed to the outside of BEV 50 (which is also referred to as “external power feed” below) is supplied from high-voltage battery 110 to charger-discharger 150. Charger-discharger 150 converts electric power supplied from high-voltage battery 110 into electric power suitable for external power feed and outputs resultant electric power to inlet 160. When any of external charging and external power feed is performed, the relay of charger-discharger 150 is closed (connected), and when neither of external charging and external power feed is performed, the relay of charger-discharger 150 is opened (disconnected).

Charger-discharger 150 and inlet 160 may be a charger-discharger and an inlet adapted to the AC type or may be a charger-discharger and an inlet adapted to the DC type. BEV 50 may include a plurality of types of chargers-dischargers and inlets so as to adapt to a plurality of types (for example, both of the AC type and the DC type).

The configuration of charger-discharger 150 is not limited as above and can be modified as appropriate. Charger-discharger 150 may include, for example, at least one of a rectification circuit, a power factor correction circuit, an insulating circuit (for example, an insulating transformer), an inverter, and a filter circuit.

MG 51 is implemented, for example, by a three-phase AC motor generator. MG 51 is driven by PCU 54 and generates driving force for traveling of BEV 50. PCU 54 includes, for example, a controller including a processor, an inverter, and a converter (none of which is shown). The controller of PCU 54 receives an instruction (a control signal) from ECU 200 and controls the inverter and the converter of PCU 54 in accordance with the instruction. PCU 54 further includes a not-shown system main relay (which is referred to as an “SMR” below). The SMR switches between connection and disconnection of an electric power path from high-voltage battery 110 to PCU 54. A state of the SMR (connection and disconnection) is controlled by ECU 200. The SMR is closed (connected) when the vehicle travels.

MG 51 is mechanically connected to driveshaft 53 with motive power transmission gear 52 serving as a reduction gear being interposed. Drive wheels (not shown) of BEV 50 are attached to respective opposing ends of driveshaft 53 and rotate integrally with driveshaft 53. MG 51 is driven by electric power supplied from high-voltage battery 110 through the inverter and the converter of PCU 54 and enters a power running state. MG 51 in the power running state rotates driveshaft 53 (and the drive wheels of BEV 50). MG 51 performs regeneration and supplies regenerated electric power to high-voltage battery 110. BEV 50 may be of any drive type, and for example, the BEV may be a front-wheel-drive vehicle or a four-wheel-drive vehicle. Though FIG. 3 shows a configuration in which only a single MG is provided, the number of MGs is not limited as such and a plurality of (for example, two) MGs may be provided.

Monitoring unit 120 includes various sensors that detect a state (for example, a temperature, a current, and a voltage) of high-voltage battery 110 and outputs a result of detection to ECU 200. ECU 200 can obtain a state (for example, a temperature, a current, a voltage, a state of charge (SOC), and an internal resistance) of high-voltage battery 110 based on an output (that is, detection values from various sensors) from monitoring unit 120. The SOC represents a remaining amount of stored power, and it is expressed, for example, as a ratio of a current amount of stored power to an amount of stored power in a fully charged state that ranges from 0 to 100%.

Communication equipment 180 includes a communication interface (I/F) for communication with each of server 30, EVSE 40, and portable terminal 80. Communication equipment 180 is registered in server 30. Communication equipment 180 may further include a communication I/F for communication with each of HEMS-GW 60 and data center 70.

ECU 200 includes a processor 210, a random access memory (RAM) 220, and a storage 230. For example, a central processing unit (CPU) can be adopted as processor 210. RAM 220 functions as a work memory that temporarily stores data to be processed by processor 210. Storage 230 can store information that is put thereinto. Storage 230 includes, for example, a read only memory (ROM) and a rewritable non-volatile memory. Storage 230 stores not only a program but also information (for example, a map, a mathematical expression, and various parameters) to be used by a program. ECU 200 communicates with equipment (for example, server 30, EVSE 40, and portable terminal 80) outside BEV 50 through communication equipment 180. Any number of processors may be provided in ECU 200 and a processor may be prepared for each prescribed type of control.

NAVI system 300 includes a controller 301, a touch panel display (which is also referred to as a “TPD” below) 302, a global positioning system (GPS) module 303, a storage 304, an operation button 305, and a speaker 306. Controller 301 includes a processor and a RAM (neither of which is shown). For example, at least one of a hard disk drive and a solid state drive (SSD) can be adopted as storage 304. Storage 304 stores map information and a path search program. In this embodiment, a smart speaker (that is, a speaker with an interactive and voice-activated artificial intelligence (AI) assistant function) is adopted as speaker 306. Without being limited as such, a general speaker that does not accept audio input may be adopted instead of the smart speaker.

TPD 302 accepts a touch input from a user or shows a map and other types of information. Speaker 306 accepts an audio input from a user or outputs sound (including voice). Operation button 305 also accepts an input from a user. Each of TPD 302, speaker 306, and operation button 305 functions as an input apparatus and outputs a signal corresponding to an input from the user to controller 301. Each of TPD 302 and speaker 306 functions as a notification apparatus and gives a notification to the user (for example, a driver and/or a passenger of BEV 50).

GPS module 303 receives a signal (which is referred to as a “GPS signal” below) from a GPS satellite (not shown). Controller 301 identifies a position of BEV 50 based on the GPS signal. By controlling TPD 302, controller 301 shows in real time a position of BEV 50 on a map shown on TPD 302. Controller 301 searches for a path for finding an optimal route (for example, the shortest route) from the current position of BEV 50 to a destination by executing a path search program, and shows the optimal route found by path search on the map shown on TPD 302. The user can set a destination in controller 301 through the input apparatus (that is, TPD 302, speaker 306, and operation button 305) described above.

Input apparatus 310 is mounted on BEV 50 separately from an input apparatus of NAVI system 300. Input apparatus 310 accepts an input from a user and outputs a signal corresponding to the input from the user to ECU 200. Communication between ECU 200 and input apparatus 310 may be wired or wireless. Examples of input apparatus 310 include various switches, various pointing devices, a keyboard, a smart speaker, and a touch panel.

Notification apparatus 320 is mounted on BEV 50 separately from a notification apparatus of NAVI system 300. Notification apparatus 320 performs prescribed processing for giving a notification to a user (for example, a driver and/or a passenger of BEV 50) when a request is given from ECU 200. Any of a display apparatus (for example, a touch panel display), a speaker (for example, a smart speaker), and a lamp (for example, a malfunction indicator lamp (MIL)) may be adopted as notification apparatus 320.

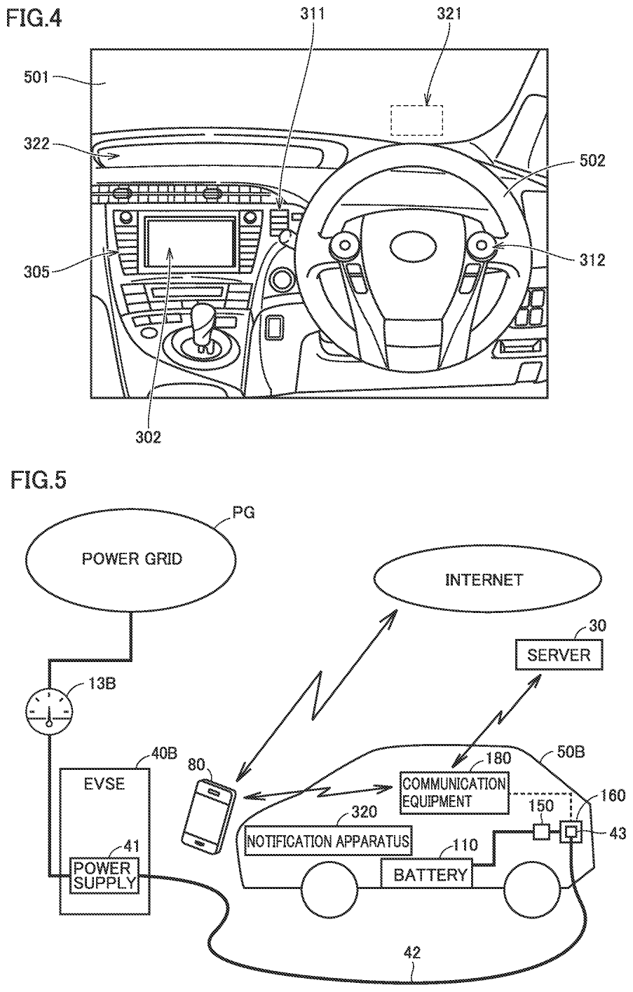

FIG. 4 is a diagram showing the input apparatus and the notification apparatus mounted in the vicinity of a driver's seat of BEV 50. Referring to FIG. 4, BEV 50 includes operation buttons 311 and 312, a head-up display (which is referred to as a “HUD” below) 321, and a meter panel 322. Operation buttons 311 and 312 are included in input apparatus 310 (FIG. 3) described previously. Operation button 311 is provided in an instrumental panel of BEV 50. Operation button 312 is provided in a steering wheel 502 of BEV 50. Each of HUD 321 and meter panel 322 is included in notification apparatus 320 (FIG. 3) described previously. HUD 321 is a display provided in a windshield 501 of BEV 50. Meter panel 322 is located in the vicinity of windshield 501 and shows information on BEV 50 (for example, a remaining capacity of the battery (SOC), a traveling speed, a travel distance, average specific power consumption, and an outdoor temperature). TPD 302 and operation button 305 of NAVI system 300 (FIG. 3) are provided in the instrumental panel of BEV 50. A main body of NAVI system 300 is arranged in the instrumental panel.

FIG. 5 is a diagram for illustrating BEV 50B connected to public EVSE 40B. Referring to FIG. 5, BEV 50B is electrically connected to EVSE 40B through charging cable 42 while it is parked in a parking lot where EVSE 40B is installed. Charging cable 42 includes connector 43 at its tip end. As connector 43 of charging cable 42 connected to EVSE 40B is connected to inlet 160 of BEV 50B, communication between BEV 50B and EVSE 40B can be established and electric power can be supplied from a power supply 41 (that is, a power supply provided outside BEV 50B) included in EVSE 40B to BEV 50B (and high-voltage battery 110). Power supply 41 is connected to power grid PG provided by electric power utility company E1 (FIG. 1) with smart meter 13B being interposed. Power supply 41 supplies electric power supplied from power grid PG to BEV 50B through charging cable 42. An amount of power usage in EVSE 40B is measured by smart meter 13B.

Communication equipment 180 mounted on BEV 50B communicates with EVSE 40B through charging cable 42. Communication equipment 180 wirelessly communicates with server 30, for example, through a mobile communication network. In this embodiment, communication equipment 180 and portable terminal 80 wirelessly communicate with each other. Communication equipment 180 and portable terminal 80 may communicate with each other through short-range communication (for example, direct communication in a vehicle or within an area around the vehicle). Though server 30 and EVSE 40B do not communicate with each other in this embodiment, server 30 and EVSE 40B may be able to communicate with each other. At least one of communication equipment 180 and portable terminal 80 may receive an amount of power usage in EVSE 40B from smart meter 13B. At least one of notification apparatus 320 and portable terminal 80 may show at least one of a value measured by smart meter 13B, a DR amount allocated to BEV 50B, and a rate of achievement of the DR amount during charging or discharging of high-voltage battery 110.

In some embodiments, an electric power service, demand or supply of electric power is leveled between/among areas. Demand or supply of electric power, however, is different from area to area.

The management server (for example, any of servers 10, 20, and 30) determines whether or not BEV 50 exchanges electric power with power grid PG with the use of second EVSE 40B provided in a second area, the second area being different in manner of management of power supply by power grid PG from a first area where predetermined first EVSE 40A is provided, first EVSE 40A being normally used by BEV 50 for exchange of electric power with power grid PG. When the management server determines that the BEV exchanges electric power with the use of second EVSE 40B and when the second area is higher than the first area in contribution to DR in exchange of electric power by BEV 50, the management server grants an incentive higher in value than in exchange of electric power with power grid PG with the use of first EVSE 40A.

Movement of BEV 50 to an area where contribution to DR is high can thus be encouraged. Consequently, contribution to leveling of demand or supply of electric power can be made.

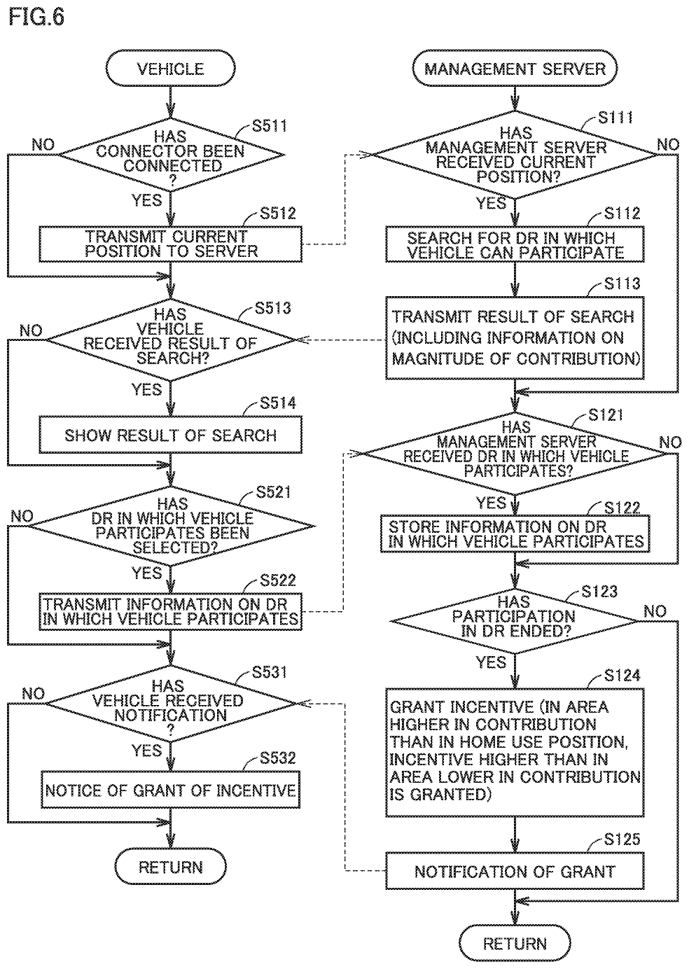

FIG. 6 is a diagram showing a flow of processing for granting an incentive for participation in a VPP. Referring to FIG. 6, initially, ECU 200 determines whether or not connector 43 of EVSE 40 has been connected to inlet 160 in BEV 50 (step S511). When ECU 200 determines that connector 43 has been connected (YES in step S511), it obtains information indicating a current position from GPS module 303 and transmits the information to the management server (any of servers 10, 20, and 30) (step S512).

In the management server, the CPU of the management server determines whether or not it has received the information indicating the current position from BEV 50 (step S111). When the CPU of the management server determines that it has received the information indicating the current position (YES in step S111), it searches for DR in which the vehicle can participate (step S112) and transmits to BEV 50, a result of search including information indicating magnitude of contribution in a case where BEV 50 participates in the DR (step S113). The contribution is represented, for example, by a ratio of electric power accounted for by BEV 50, of electric power necessary in DR such as DR increase, DR suppression, or DR increase and suppression. In an example where electric power necessary in DR is 100 kW and electric power accounted for by BEV 50 is 1 kW, contribution by BEV 50 is calculated as 1 (kW)/100 (kW)=1 (%). In an example where participation by one hundred BEVs 50 in DR is required, the contribution by BEV 50 is calculated as 1 (car)/100 (cars)=1 (%). Since demand and supply of electric power are different between/among areas where a manner of management of power supply by power grid PG is different, the contribution by BEV 50 in DR is different.

ECU 200 of BEV 50 determines whether or not it has received a result of search from the management server (step S513). When ECU 200 determines that it has received the result of search (YES in step S513), it has the result of search shown on TPD 302 (step S514). In this case, the contribution by BEV 50 for each DR in which the BEV can participate is also shown.

ECU 200 determines whether or not DR in which the user of BEV 50 desires to participate has been selected based on the result of search shown on TPD 302 (step S521). When ECU 200 determines that DR in which the user desires to participate has been selected (YES in step S521), it transmits information indicating DR in which the user desires to participate to the management server (step S522).

The CPU of the management server determines whether or not it has received information indicating DR in which the user desires to participate from BEV 50 (step S121). When the CPU of the management server determines that it has received the information indicating DR in which the user desires to participate (YES in step S121), it has the information stored in the storage of the management server in correspondence with a vehicle ID for identification of BEV 50, the information indicating DR in which the user desires to participate (step S122).

When time to start DR in which the user desires to participate comes, control of DR is started and exchange of electric power between BEV 50 and power grid PG is started.

The CPU of the management server determines whether or not participation by BEV 50 in DR has ended (step S123). When the CPU of the management server determines that participation in DR has ended (YES in step S123), it grants an incentive to the user of BEV 50 (step S124). In this grant of the incentive, in an area provided with power grid PG where contribution to DR is higher than an area provided with power grid PG which is a base area where BEV 50 is normally used, a higher incentive is granted than in an area provided with power grid PG where the contribution is low. In an example where the contribution to the DR at a position in the base area where BEV 50 is normally used is 1%, when the BEV participates in DR in an area where the contribution is higher at 2%, a more incentive (for example, a more incentive in proportion to the contribution; in an example where the contribution is a time higher, an incentive ak time higher (k representing a proportionality constant)) is granted. The incentive may be granted in a form of money, value (for example, points) equivalent to the monetary value, or a rate or an amount of discount of electricity fee.

The CPU of the management server notifies BEV 50 of grant of the incentive (step S125).

ECU 200 of BEV 50 determines whether or not it has received a notification of grant of the incentive from the management server (step S531). When ECU 200 determines that it has received the notification (YES in step S531), it gives notice of grant of the incentive through TPD 302 or speaker 306 (step S532).

[Modification]

(1) In the embodiment described previously, electric power utility company E1 is assumed as the electric power trading partner. Without being limited as such, another entity which is not a power generation utility such as electric power utility company E1 may be applicable as the electric power trading partner. The electric power trading partner may be, for example, a general power transmission and distribution utility, a retail electric utility, or a demand side of electric power such as a general entity.

(2) In the embodiment described previously, power grid PG is defined as the power supply and demand system of the electric power trading partner. Without being limited as such, another system may be defined as the power supply and demand system of the electric power trading partner. For example, a system of power lines in a business establishment may be applicable.

(3) In the embodiment described previously, BEV 50 is defined as the electrically powered vehicle. Without being limited as such, the electrically powered vehicle should only be a vehicle including a power storage and being capable of external charging and discharging. For example, a PHEV or a plug-in fuel cell electric vehicle (FCEV) may be applicable.

(4) In the embodiment described previously, the contribution in an area where BEV 50 participates in DR is compared with the contribution at a position in the base area where BEV 50 is normally used. What is compared with, however, is not limited to the position in the base area where BEV 50 is normally used, and any other area where predetermined EVSE 40 normally used by the BEV is provided may be applicable.

(5) In the embodiment described previously, as shown in steps S511 to S514 and steps S111 to S113 in FIG. 6, on condition that the connector of EVSE 40 is connected to BEV 50, DR in which the user can participate is proposed to the user. Without being limited as such, the user may designate an area on an information terminal such as a portable terminal to search for DR in which the user can participate in that area, and thereafter participate in DR in that area.

(6) In the embodiment described previously, though the incentive is granted for actual participation in DR, limitation as such is not intended. Movement of BEV 50 from an area obviates the need for charging of BEV 50 in the area from which BEV 50 has moved and necessitates charging of BEV 50 in an area into which BEV 50 has moved. Therefore, the contribution to DR suppression increases in the area from which the BEV has moved and the contribution to DR increase increases in the area into which the BEV has moved. Therefore, the user of BEV 50 may be granted the incentive for this contribution.

(7) The embodiment described previously can be understood as disclosure of such a power management system as VGI system 1, disclosure of the power management method in the power management system, disclosure of servers 10, 20, 30, EVSE 40, or BEV 50, or disclosure of the power management method performed in servers 10, 20, 30, EVSE 40, or BEV 50 or a power management program executed by servers 10, 20, 30, EVSE 40, or BEV 50.

### SUMMARY

(1) As shown in FIGS. 1 and 2, VGI system 1 is a system in which electric power is exchanged between power grid PG of electric power utility company E1 and BEV 50. As shown in FIGS. 1 and 2, VGI system 1 includes a plurality of BEVs 50, a plurality of pieces of EVSE 40 each including charging cable 42 through which electric power exchanged with BEV 50 passes and connector 43 for connection of charging cable 42 to BEV 50, and the management server (for example, any of servers 10, 20, and 30) that manages exchange of electric power. As shown in FIG. 6, the management server determines whether or not BEV 50 exchanges electric power with power grid PG with the use of second EVSE 40 provided in a second area (for example, step S511), the second area being different in manner of management of power supply by power grid PG from a first area where predetermined first EVSE 40 is provided, first EVSE 40 being normally used by BEV 50 for exchange of electric power with power grid PG. When the server determines that the BEV exchanges electric power with the use of second EVSE 40 and when the second area is higher than the first area in contribution to DR in exchange of electric power by BEV 50, the management server grants an incentive higher in value than in exchange of electric power with power grid PG with the use of first EVSE 40 (for example, step S124).

Movement of BEV 50 to an area where contribution to DR is high can thus be encouraged. Consequently, contribution to leveling of demand or supply of electric power can be made.

(2) As shown in FIG. 6, the management server may propose to a user of BEV 50, DR in which BEV 50 can participate in the second area (for example, step S514).

Movement of BEV 50 to the second area can thus be encouraged, which can result in contribution to leveling of demand or supply of electric power in the second area.

(3) As shown in FIG. 6, the management server may show to the user of BEV 50, contribution by BEV 50 for each DR in the second area (for example, step S514).

Movement of BEV 50 to the second area can thus be encouraged. Consequently, contribution to leveling of demand or supply of electric power in the second area can be made.

(4) As shown in FIG. 6, the management server may propose to the user of BEV 50, DR in which BEV 50 can participate on condition that connector 43 of second EVSE 40 is connected to BEV 50 (for example, step S511, step S514).

An incentive can thus be granted on condition that contribution to DR can actually be made.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A power management system in which electric power is exchanged between a power supply and demand system of an electric power trading partner and a vehicle, the power management system comprising:
a plurality of vehicles;
a plurality of charging and discharging apparatuses each including a cable through which electric power exchanged with the vehicle passes and a connector for connection of the cable to the vehicle; and
a server that manages exchange of electric power, wherein
in a first area, a predetermined first charging and discharging apparatus normally used by the vehicle for exchange of electric power with the power supply and demand system is provided,
a second charging and discharging apparatus is provided in a second area different from the first area in manner of management of power supply by the power supply and demand system,
the server
determines whether the vehicle exchanges electric power with the power supply and demand system by using the second charging and discharging apparatus, and
when the server determines that the vehicle exchanges electric power by using the second charging and discharging apparatus and when the second area is higher than the first area in contribution to demand response in exchange of electric power by the vehicle, grants an incentive higher in value than in exchange of electric power with the power supply and demand system by using the first charging and discharging apparatus.

2. The power management system according to claim 1, wherein
the server proposes to a user of the vehicle, demand response in which the vehicle can participate in the second area.

3. The power management system according to claim 2, wherein
the server shows the user of the vehicle, contribution by the vehicle for each demand response in the second area.

4. The power management system according to claim 2, wherein
the server proposes to the user of the vehicle, demand response in which the vehicle can participate on condition that the connector of the second charging and discharging apparatus is connected to the vehicle.

5. A power management method in a power management system in which electric power is exchanged between a power supply and demand system of an electric power trading partner and a vehicle,
the power management system including
a plurality of vehicles,
a plurality of charging and discharging apparatuses each including a cable through which electric power exchanged with the vehicle passes and a connector for connection of the cable to the vehicle, and
a server that manages exchange of electric power,
in a first area, a predetermined first charging and discharging apparatus normally used by the vehicle for exchange of electric power with the power supply and demand system being provided,
a second charging and discharging apparatus being provided in a second area different from the first area in manner of management of power supply by the power supply and demand system,
the power management method comprising:
determining, by the server, whether the vehicle exchanges electric power with the power supply and demand system by using the second charging and discharging apparatus; and
granting, by the server, when the server determines that the vehicle exchanges electric power by using the second charging and discharging apparatus and when the second area is higher than the first area in contribution to demand response in exchange of electric power by the vehicle, an incentive higher in value than in exchange of electric power with the power supply and demand system by using the first charging and discharging apparatus.
